(19) United States
(12) Patent Application Publication
(10) Pub. No.: US 2025/0341050 A1
(43) Pub. Date: Nov. 6, 2025

(54) Bio-Based Artificial Leather and Method

(71) Applicants: Dean Webster, Tucson, AZ (US); Long Jiang, Tucson, AZ (US); Marta-levheniia Vonsul, Tucson, AZ (US); Austin Knight; Mohammad Sazbi, Tucson, AZ (US)

(72) Inventors: Dean Webster, Fargo, ND (US); Long Jiang, Fargo, ND (US); Marta-levheniia Vonsul, Fargo, ND (US); Austin Knight, Fargo, ND (US); Mohammad Sazbi, Fargo, ND (US)

(21) Appl. No.: 19/196,413

(22) Filed: May 1, 2025

Related U.S. Application Data
(60) Provisional application No. 63/641,155, filed on May 1, 2024.

(51) Int. Cl. D06N 3/16; C08G 59/34; C08G 59/42; C08J 5/12; D06N 3/00

(52) U.S. Cl. CPC D06N 3/16; C08G 59/34; C08G 59/4207; C08J 5/12; D06N 3/0006; D06N 3/0015; D06N 3/0045; C08J 2363/08; D06N 2201/042

(57) ABSTRACT

There is disclosed a bio-based artificial leather composition, which includes a base layer having a first polymerized epoxidized vegetable oil. The composition also includes a foam layer attached to the base layer and having a second polymerized epoxidized vegetable oil. The bio-based artificial leather also includes a fabric layer attached to the foam layer. There is also disclosed a method of preparing a bio-based artificial leather composition including the step of providing a first epoxidized vegetable oil and polymerizing the epoxidized vegetable oil to form a base layer. The method also includes the step of providing a second epoxidized vegetable oil and curing the second epoxidized vegetable oil with an anhydride and foaming agent to form a foam layer. The base layer is attached to the foam layer. A fabric layer is attached to the foam layer.

### CROSS-REFERENCE TO RELATED APPLICATIONS

This application is a continuation-in-part application of U.S. Provisional Patent Application No. 63/641,155, filed May 1, 2024, and entitled “BIOBASED ARTIFICIAL LEATHER COMPOSITIONS AND METHODS OF PREPARING THE SAME,” the entire disclosure of which is incorporated herein by reference.

### TECHNICAL FIELD

This disclosure relates to bio-based artificial leather compositions and methods of preparing the same.

### BACKGROUND

Sustainability concerns in various fields of industrial production have led to increased utilization of natural resources as raw materials. Although leather is a renewable and bio-based material, its production has been increasingly scrutinized due to environmental issues associated with tanning, dyeing, and other manufacturing processes. In parallel, there is a growing segment of consumers opposed to the use of animal-derived products. These factors have created challenges for the continued development and acceptance of products made from genuine leather. Accordingly, since at least the 1950s, artificial leather has been widely adopted for use in industrial and consumer applications.

Natural leather exhibits a combination of desirable properties, including water vapor permeability, abrasion resistance, a balance of strength and elasticity, durability, and long service life. Artificial leather materials have been developed to replicate these properties, achieving comparable mechanical and functional performance in many applications. Conventional synthetic leathers are typically produced using polymeric materials such as polyvinyl alcohol (PVA) and polyurethane (PU). However, such petroleum-derived polymers are increasingly viewed as incompatible with environmental sustainability objectives. As a result, ongoing research efforts have been directed toward the incorporation of renewable, bio-based materials into the formulation and manufacture of artificial leather compositions.

### SUMMARY

In a first aspect, the disclosure provides a bio-based artificial leather composition, which includes a base layer having a first polymerized epoxidized vegetable oil. The composition also includes a foam layer attached to the base layer and having a second polymerized epoxidized vegetable oil. The bio-based artificial leather also includes a fabric layer attached to the foam layer.

In accordance with a preferred embodiment, the first and second epoxidized vegetable oil are both epoxidized cottonseed oil. In this same embodiment, the epoxidized cottonseed oil is cured with an anhydride, such as dodecenyl succinic anhydride (DDSA). Also. the fabric layer is preferably made from cotton.

In the method aspect, the disclosure provides a method of preparing a bio-based artificial leather composition including the step of providing a first epoxidized vegetable oil, and polymerizing the epoxidized vegetable oil to form a base layer. The method also includes the step of providing a second epoxidized vegetable oil and curing the second epoxidized vegetable oil with an anhydride and foaming agent to form a foam layer. The base layer is attached to the foam layer. A fabric layer is attached to the foam layer.

In accordance with a preferred embodiment of the method, the first and second epoxidized vegetable oil are both epoxidized cottonseed oil. In this preferred method embodiment, the epoxidized cottonseed oil for both the base layer and the foam layer is cured with an anhydride, such as dodecenyl succinic anhydride (DDSA). Also. the fabric layer is preferably made from cotton.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a schematic representation of the bio-based artificial leather of the present invention.

FIG. 2 is collection of microscopic images of ECO-based foams.

FIG. 3 is a graph showing the dynamic mechanical analysis of UV-cured AECO base layer.

FIG. 4 is a graph showing the thermogravimetric curve of AECO dual cured film for the base layer.

FIG. 5 is a graph showing the dynamic mechanical analysis of AECO dual cured film for the base layer.

FIG. 6 is a graph of the DSC of cured base layer at 160° C.

FIG. 7 is a graph showing the on-isothermal DSC of the base formulation (right after preparation).

FIG. 8 is the thermogravimetric curves of uncured formulation and cured base film.

FIG. 9 is a graph showing a non-isothermal DSC of the base formulation pre-cured at 120° C.

FIG. 10 is graph showing the non-isothermal DSC of the base films (first heating cycle).

FIG. 11 is a collection of optical microscope images of foams with different concentrations of blowing agent ADA.

FIG. 12 is collection of optical microscope images of foams with different concentrations of foaming accelerator ZnO

FIG. 13 is a SEM scan of a sample made with 3 pph ADA and 0.5 pph ZnO.

FIG. 14 is another SEM scan at a higher magnification of a sample made with 3 pph ADA and 0.5 pph ZnO.

FIG. 15 is a MicroCT scan of foam made with 3 pph ADA and 0.5 pph ZnO.

FIG. 16 is an SEM image of a sample pre-cured with ADA and ZnO.

FIG. 17 is an SEM image of a sample pre-cured without ADA and ZnO.

FIG. 18 is an SEM scan of a sample pre-cured with ADA and ZnO

FIG. 19 is an SEM scan of a sample pre-cured without ADA and ZnO.

FIG. 20 is two SEM scans of sample prepared with a surfactant.

FIG. 21 is a MicroCT scan of foam made with 3 pph ADA and 0.5 pph ZnO with surfactant, not pre-cured.

FIG. 22 is a MicroCT scan of foam made with 3 pph ADA and 0.5 pph ZnO with surfactant and pre-cured.

FIG. 23 is a graph showing the temperature dependence of tan delta and storage modulus of a sample.

FIG. 24 is graph showing the thermal stability of the ECO-based foams made with different amount of ADA.

FIG. 25 is a bar graph showing the decomposition temperatures (Td (95%)) of the ECO-based foams made with different contents of ZnO.

FIG. 26 is a series of graphs showing the mechanical properties of the CSO leather developed previously, the improved CSO leather, Desserto®, and Pinatex® leathers obtained using tensile testing.

FIG. 27 is a graph showing the tensile testing curves of representative specimens closest to the average mechanical properties for the CSO leather developed previously, the improved CSO leather, Desserto®, and Pinatex® leathers.

FIG. 28 is a series of graphs showing the modulus, ultimate strength, ultimate strain, and toughness of the commercial and ECSO synthetic leathers.

FIG. 29 is a graph showing the tensile curves of representative specimens are closest to the average mechanical properties of the DDSA: THPA formulation on woven canvas and the DDSA formulation on knit cotton.

FIG. 30 is a graph showing the representative tensile curves of the CSO knit cotton, knit cotton, and Desserto® commercial synthetic leather.

FIG. 31 is a 20× magnification of the ECSO leather surface using Opt-SEM.

FIG. 32 is an 80× magnification of the ECSO leather.

FIG. 33 is a schematic drawings of a lab scale continuous artificial leather manufacturing device.

FIG. 34 is a schematic drawing of a conveyor system with a furnace to cure the polymers.

FIG. 35 is a schematic drawing of the system shown in FIG. 34, with the insulation removed to show the heater and screed blade.

FIG. 36 schematically depicts a lamination device by which the base layer, foam layer and fabric layer are brought together.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

So that the present invention may be more readily understood, certain terms are first defined. Unless defined otherwise, all technical and scientific terms used herein have the same meaning as commonly understood by one of ordinary skill in the art to which embodiments of the disclosure pertain. While many methods and materials similar, modified, or equivalent to those described herein can be used in the practice of the embodiments of the present disclosure without undue experimentation, the preferred materials and methods are described herein. In describing and claiming the embodiments of this disclosure, the following terminology will be used in accordance with the definitions set out below.

All terminology used herein is for the purpose of describing particular embodiments only and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the invention. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

References to elements herein are intended to encompass any or all of their oxidative states and isotopes.

The term “about,” as used herein, refers to variation in the numerical quantity that can occur, for example, through typical measuring techniques and equipment, with respect to any quantifiable variable, including, but not limited to, adhesion, elongation, hardness, impact, mass, time, temperature, and volume. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

As used herein, the term “bio-based” refers to materials, products, or chemicals that are derived from biological resources—such as plants, animals, microorganisms, or renewable agricultural, forestry, or marine sources—rather than from fossil fuels or minerals. For example, acrylated epoxidized vegetable oil and anhydride cured epoxidized vegetable oil are both considered bio-based polymers.

As used herein, the term “vegetable oil” refers to an oil that is extracted from the seeds, fruits, or other parts of plants. These oils are primarily composed of triglycerides-molecules formed from glycerol and fatty acids.

As used herein, the term “cottonseed oil” refers to the vegetable oil extracted from the seeds of the cotton plant (Gossypium species), a byproduct of cotton fiber production. Cottonseed oil has a typical fatty acid profile of Linoleic acid (˜50%), Oleic acid (˜18%), Palmitic acid (˜22%), and Stearic acid (˜3%).

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

The term “fabric” includes woven and non-woven textiles. Woven fabrics include knitted fabrics.

As used herein, the term “epoxidized vegetable oil” refers to bio-based oils derived from natural vegetable oils (e.g., soybean, linseed, cottonseed, sunflower oil) in which the unsaturated sites (double bonds) in the fatty acid chains have been chemically modified to contain epoxide (oxirane) functional groups. These epoxides are reactive and make the oils suitable for use in the production of polymers.

As used herein the term “polymer” refers to a molecular complex comprised of more than ten monomeric units and generally includes, but is not limited to, homopolymers, copolymers, such as for example, block, graft, random and alternating copolymers, terpolymers, and higher “x” mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

The term “weight percent,” “wt. %,” “wt-%,” “percent by weight,” “% by weight,” and variations thereof, as used herein, refer to the concentration of a substance as the weight of that substance divided by the total weight of the composition and multiplied by 100.

### Bio-Based Artificial Leathers

The bio-based artificial leathers disclosed herein comprise a base layer, a foam layer, and a fabric layer or backing. The base layer comprises an epoxidized vegetable oil. The foamed layer also comprises an epoxidized vegetable oil. In a most preferred embodiment, the fabric layer is formed from cotton fibers, such as in a knit cotton fabric.

In a preferred embodiment, the fabric comprises a natural fabric, semisynthetic fabric, synthetic fabric, or a combination thereof.

Preferred natural fabrics include, but are not limited to, those comprising cotton, linen, hemp, jute, silk, wool, and combinations thereof.

Preferred semisynthetic fabrics include, but are not limited to, those comprising rayon, acetate, triacetate, and combinations thereof.

Synthetic fabrics can include, but are not limited to, those comprising nylon, polyester, acrylic fibers, olefin fibers, spandex, aramid and combinations thereof. In a most preferred embodiment, the composition does not include a synthetic fabric.

Any suitable vegetable oil can be utilized in preparation of the base layer and/or foam layer. Preferred vegetables oils, include, but are not limited to, avocado, brazil nut, canola, coconut, corn, cottonseed, flaxseed, grapeseed, hazelnut, hempseed, jambu, linseed, olive, palm, peanut, rapeseed, rice bran, safflower, sesame, soybean, sunflower, walnut, and combinations thereof. Cottonseed oil is the preferred vegetable oil.

In a preferred embodiment, the foam layer is prepared from an epoxidized vegetable oil. In this respect, a vegetable oil can be obtained and epoxidized to form an epoxidized vegetable oil. Preferably, the foam layer is prepared by thermal curing the epoxidized vegetable oil in the presence of an anhydride and foaming agent. Any suitable foaming agent can be utilized.

In a preferred embodiment, the base layer is prepared from an acrylated-epoxidized vegetable oil. An epoxidized vegetable oil can be acrylated to form an acrylated-epoxidized vegetable oil. Preferably the base layer is prepared by UV-curing the acylated-epoxidized vegetable oil.

In another preferred embodiment, the base layer is prepared by thermal curing with an anhydride, such as dodecenyl succinic anhydride (DDSA).

The fabric layer can be provided by obtaining any suitable fabric material or by preparing a fabric material. In this respect the fabric material can be bio-based, animal based, and/or synthetic. In a most preferred embodiment, it is bio-based, namely a cotton-based fabric.

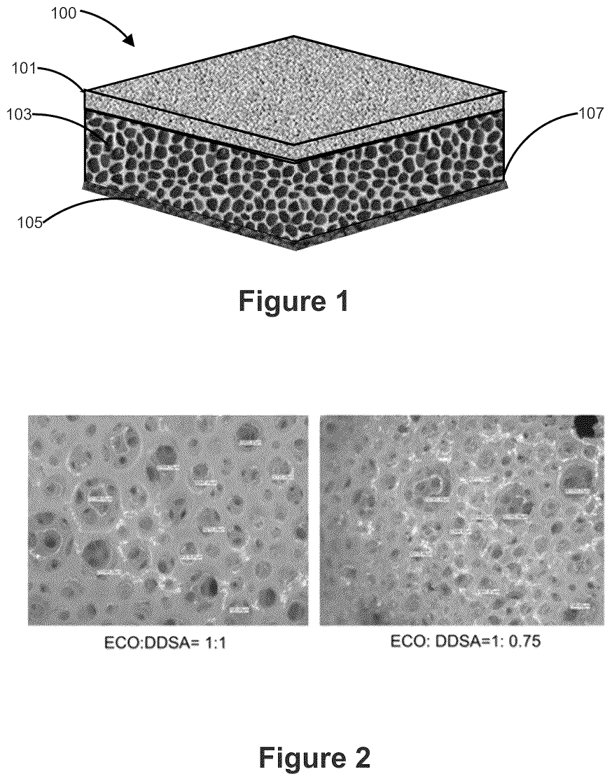

FIG. 1 schematically depicts the structure of the bio-based artificial leather 100 of the present invention. The artificial leather consists of three layers: the first, a thin base layer 101, the second, thick foam layer 103 and the third, a fabric layer 105. In between the foamed layer and the fabric layer, there is one more layer 107 of adhesive or “glue”, which preferably consists of the base layer formulation. This glue layer may be used to adhere the fabric to other layers.

### EXAMPLES

Preferred embodiments of the disclosure are further described in the following non-limiting Examples. It should be understood that these Examples, while indicating certain embodiments of the disclosure, are given by way of illustration only. From the above discussion and these Examples, one skilled in the art can ascertain the essential characteristics of the invention, and without departing from the spirit and scope thereof, can make various changes and modifications of the embodiments disclosed herein to adapt to various usages and conditions. Thus, various modifications of the preferred embodiments, in addition to those shown and described herein, will be apparent to those skilled in the art from the foregoing description. Such modifications are also intended to fall within the scope of the appended claims.

### Example 1

### 1. Materials

Cottonseed oil was provided by Chef's Pride. The following materials were used for synthesis of resins: ion-exchange resin catalyst, Amberlite IR120; 50% aqueous H₂O₂; acetic acid; hexane; saturated sodium carbonate; saturated sodium chloride; magnesium sulfate anhydrous; acrylic acid (99.5%); AMC—2 catalyst; hydroquinone. Blowing/foaming agent azodicarbonamide and accelerators of foaming zinc stearate and zinc oxide were used for producing foamed layers of the artificial leather. Dodecenyl succinic anhydride (DDSA) was used in preparation of epoxidized cottonseed oil (ECO) ECO-foamed layer. Catalysts BV-CAT 7 and 1,8-diazabicyclo (5.4.0) undOec-7-ene (DBU) were used in thermally cured ECO-based layers. Omnirad 1173 (2-hydroxy-2-methyl-1-phenylpropanone) photoinitiator was used to make UV- curable and dual cured layers of leather. Luperox P (tert-butyl peroxybenzoate) thermal initiator was used to formulate dual cured layers of leather.

### 2. Synthesis of Resins

### 2.1 Synthesis of Epoxidized Cottonseed Oil

The epoxidation process was performed via in-situ generation of peracetic acid. A 3000 mL four-necked round bottom flask equipped with a mechanical stirrer, addition funnel, condenser and thermocouple were placed in a heating mantle. The flask was charged with a predetermined amount of oil, Amberlite IR120H and acetic acid. The addition funnel was equipped with a nitrogen gas inlet and charged with a predetermined amount of 50 wt % hydrogen peroxide. The reaction was heated to 60° C. Once the temperature reached 55° C., the hydrogen peroxide was added to the reaction. The reaction temperature was maintained at 60° (±5° C.) during the whole reaction time. After the reaction was completed, the contents of the reaction flask were transferred to a separatory funnel and were allowed to separate overnight. The bottom layer was discarded and neutralized. The remaining contents of the separatory funnel were dissolved in hexane and neutralized utilizing a sodium bicarbonate solution. Finally, the contents were washed with brine. The remaining organic layer was dried using magnesium sulfate. Following this, hexane was removed with the help of rotary evaporator.

Product was fully analyzed by combined spectroscopy methods (FTIR, H1 NMR, GPC).

The epoxy equivalent weight of the synthesized resin was determined following ASTM D1652.

### 2.2. Synthesis of Acrylated-Epoxidized Cottonseed Oil

Acrylated-epoxidized cottonseed oil (AECO) was synthesized from epoxidized cottonseed oil (ECO) by reacting it with acrylic acid. The reactions were carried out in 250 mL round bottom flask, equipped with a condenser, a heating mantle and a thermocouple. All contents, namely, acrylic acid, epoxidized cottonseed oil, catalyst and inhibitor were placed in the flask and heated up to 100° C., while being mechanically stirred. The completion of the reaction was monitored by acid value titrations.

### 3. Preparation of Leather Foam Layer

Catalyst BV-CAT 7 (DBU can be also used) were added first to ECO and mixed for 2 min in a FlackTek mixer. The amount of catalyst was kept at 3% by the total weight of the epoxy compound and anhydride. Following this, dodecynyl succinic anhydride was added to the formulation and mixed for 2 min again. The equivalent ratio of epoxy to anhydride (ECO: anhydride) was varied from 1:0.75 to 1:1.5. The foaming agent azodicarbonamide (ADA) and accelerator of foaming —ZnO (Zn stearate can be also used) were added to the mixture. The amount of ADA to ZnO was 4 pph and 1 pph respectively (pph=parts per hundred of the total weight of epoxy compound and anhydride). The formulation was mixed in a Flacktek Speed mixer at 3500 rpm for 2 min and poured into a silicon mold or applied with drawdown bar on glass panels and cured in the oven.

### 4. Preparation of Leather Base Layer

### 4.1 Thermally Cured Base Layer from ECO

Catalyst BV-CAT 7 (DBU can be also used) were added first to ECO and mixed for 2 min in a FlackTek mixer. The amount of catalyst was kept at 3% by the total weight of the epoxy compound and anhydride. Following this, dodecynyl succinic anhydride (DDSA) was added to the formulation and mixed for 2 min again. The equivalent ratio of epoxy to anhydride (ECO: anhydride) was varied from 1:0.75 to 1:1.5. Formulations were applied on steel substrates (Q-Lab, QD-36) and glass panels cleaned with acetone and cured in the oven.

### 4.2 UV-Curable Base Layer from AECO

A formulation, containing Acrylated Epoxidized Cottonseed Oil (AECO) resin and photoinitiator-Omnirad 1173 (1% by weight) was mixed in a FlackTek Speed mixer at 3500 rpm for 3 min. Following this, formulations were applied on steel (Q-Lab, QD-36) and glass panels using a drawdown bar at a wet film thickness of 8 mil. The coatings were cured by exposure to UV radiation using a Fusion LC6B Benchtop Conveyer with an F300 Lamp at speed 3. Total exposure measurements were: ˜1190 mW/cm² (UVA); ˜310 mW/cm² (UVB); ˜50 mW/cm² (UVC); ˜1020 mW/cm² (UVV), as determined by a UV Power Puck II (EIT Inc.).

### 4.3 Dual Cured Base Layer from AECO

Formulations, containing AECO resin, free-radical thermal initiator-Luperox P, and Photoinitiator-Omnirad 1173, were prepared by mixing in a FlackTek Speed mixer at 3500 rpm for 2 min. Formulations were applied on steel (Q-Lab, QD-36) and glass panels, cleaned with acetone, using a drawdown bar at a wet film thickness of 8 mil. The coatings were cured by exposure to UV radiation using a Fusion LC6B Benchtop Conveyer with an F300 Lamp at speed 4. Total exposure measurements were: ˜1390 mW/cm² (UVA); ˜360 mW/cm² (UVB); ˜53 mW/cm² (UVC); ˜1120 mW/cm² (UVV), as determined by a UV Power Puck II (EIT Inc.). Following this, the coatings were cured in the oven at 150° C. for 1 hour.

### 4.4 Co-Curing of ECO Base Layer and ECO Foamed Layer

The base layer formulation (procedure 4.1) was applied on glass panels with a drawdown bar. Following this, the foamed layer formulation (procedure 3) was applied on top of the base layer and cured in the oven for 30 min at 160° C.

### 5. Characterization of Layers

### 5.1 Mechanical Properties of Base Layers

After curing, the coating's properties were characterized. Hardness was defined by subjecting coatings to a König pendulum hardness test (ASTM D4366), as well as the pencil hardness test (ASTM D3363). The thickness of each of the coatings was measured with a coating Byko-Test 8500 thickness gauge. Adhesion to the substrates was characterized by crosshatch adhesion test (ASTM D3359). Conical mandrel bend test (ASTM D522) and reverse impact test (ASTM D2794) were performed in order to determine flexibility and rapid deformation respectively.

### 5.2 Microscopic Images of Foamed Layers

Microscopic images of layers were captured using a Keyence VNX-E100 Digital Microscope. The measurements of size of the pores were taken in different places with 50 times magnification.

### 5.3 Thermomechanical Analyzes of Base Films

Free films of the coatings were removed from glass panels and the rectangular samples (length ˜15 mm; width=5 mm; thickness ˜0.20 mm) were prepared.

### 5.3.1 Thermogravimetric Analysis (TGA)

TGA was used to determine the thermal stability of the cured thermosets. Samples were analyzed using a Q500 thermogravimetric analysis system (TA Instruments). They were heated from room temperature to 600° C. with heating rate 10° C./min. The decomposition temperatures of the films were determined as the temperatures of 5% weight loss (T_{d} (5%).

### 5.3.2 Dynamic Mechanical Analysis (DMA)

DMA was performed on a TA Instruments Q800 dynamic mechanical analyzer. Free films with a thickness of 0.20 mm were locked in the single cantilever clamp. Samples were run from −50° C. to 200° C. with a heating rate of 5° C./min. The T_{g} of the coatings were defined as a tan δ peak. The glass transition temperatures of the films were defined as the tan δ peak. The storage modulus was determined at 60° C. above the T_{g}.

### 5.3.3 Differential Scanning Calorimetry (DSC)

A TA Instruments Q1000 modulated differential scanning calorimeter was used to study the curing behavior of the base layer from ECO. Each cured sample was placed in an aluminum pan and run with a heating rate of 5° C./min from room temperature to 300° C. Then, the samples were cooled down to −50° C. and heated again to 300° C. with a heating rate of 5° C./min.

### 5.3.4 Gel Content

The gel content of the base layer films and foamed layer molds was determined via the Soxhlet method. Samples were placed in a paper thimble, which was then inserted into a Soxhlet extractor. The toluene was circulated through the extractor for 24 h. Samples were removed from the thimble and dried in the oven for several hours. The weight of the samples was measured, and the gel content was calculated as the final weight/initial weight.

### 5.3.5 Scanning Electron Microscopy (SEM)

SEM was performed in order to define the cell structure of the prepared foams. To view the internal structure, a transverse slice was removed from each foam sample with a razor blade. Slices were attached to cylindrical aluminum mounts with silver paste (SPI Products, West Chester, Pennsylvania, USA). Mounted specimens were sputter-coated (Cressington 108auto, Ted Pella, Redding, California, USA) with a conductive layer of gold. Images were obtained with a JEOL JSM-6490LV scanning electron microscope (JEOL USA, Inc., Peabody MA, USA.

### 5.3.6 Micro Computed Tomography (MicroCT)

MicroCT was used as a non-destructive way to image the internal structure of the ECO-based foams and define their porosity. Each foam sample was scanned in a GE Phoenix v|tome| x s X-ray computed tomography system (MicroCT) equipped with a 180 kV nanofocus X-ray tube and a high-contrast GE DXR250RT flat panel detector (GE Sensing & Inspection Technologies GmbH, Niels Bohr Str 7, 31515 Wunstorf, Germany). At a voltage of 60 kV and a current of 350 μA with a molybdenum target, 600 projections were acquired.

Detector timing was 500 msec. Sample magnification was 5.26× with a voxel size of 38.02 μm. Acquired images were reconstructed into a volume data set using GE datos|x 3D computer tomography software version 2.2 (GE Sensing & Inspection Technologies GmbH, Niels Bohr Str 7, 31515 Wunstorf, Germany). The reconstructed volume was then viewed, and porosity analysis was performed using VGStudio Max version 2023.1 (Volume Graphics, Inc., 3219 Arbor Pointe Drive, Charlotte, North Carolina, USA 28210).

### Results and Discussion

### Synthesis of ECO and AECO Resins

The epoxidation process of cottonseed oil was performed by the peracetic method, in which hydrogen peroxide reacts with acetic acid to form peracetic acid. Then the peracetic acid reacts with the double bonds in fatty acids chain of the cottonseed oil to form oxirane rings. The reaction is shown below:

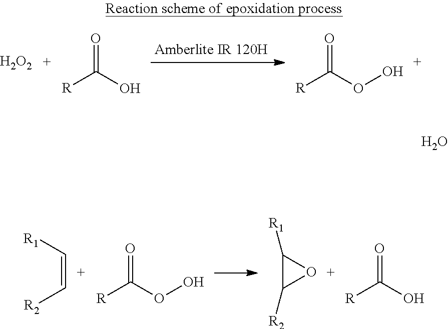

The amounts of reagents (acetic acid, hydrogen peroxide and Amberlite) used during epoxidation were calculated based on molar ratios relative to double bonds. After the epoxidation, the epoxy equivalent weight of the synthesized resin was measured according to ASTM D 1652. The measured value corresponded to 277.66 g/mol. Following this, acrylated epoxidized cottonseed oil (AECO) was synthesized from ECO and acrylic acid according to the process shown below:

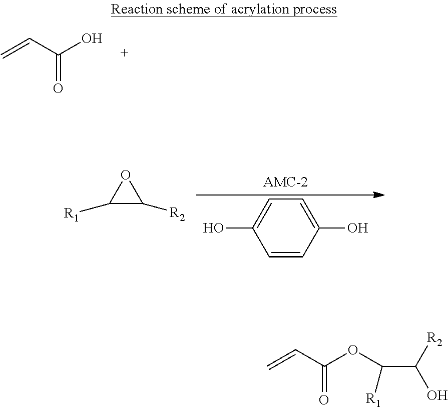

In this reaction, the acrylic acid reacts with the epoxy ring presented in the epoxidized cottonseed oil in presence of chromium-based AMC-2 catalyst. The final acid number was around 10. The structure of both synthesized materials was confirmed by combined spectroscopy methods.

The most preferred method of producing the foamed layer of artificial leather from cottonseed oil was defined as a method that uses thermal curing of ECO with anhydrides. This method allows the formation of a porous and flexible foam, which is needed in artificial leather applications. However, it is important to mention that the choice of anhydride in the foamed formulation can be important, since it can impact the final properties of the produced foams. For example, it was found that methylhexahydrophthalic anhydride (MHHPA) was not as effective for thermal curing with ECO resin because of its high vapor pressure. This anhydride can be easily volatilized from the foamed formulation. Since the curing temperature of the foams is relatively high (160° C.), evaporation could occur before the anhydride completely reacts with ECO. Another issue with having this anhydride in the foamed formulation is related to its rigid cycloaliphatic structure shown below, which can give some hardness and brittleness to the ECO-based foams.

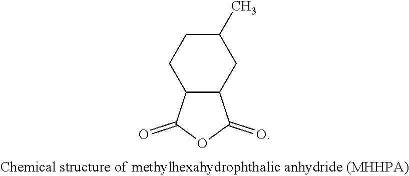

In comparison to MHHPA, DDSA, having a long aliphatic chain, imparts flexibility and softness to the ECO-based foams. The chemical structure of DDSA is shown below. Therefore, this anhydride was used in producing the foamed layer of cottonseed oil-based leather.

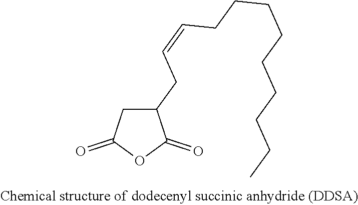 [SMILES: CCCCCCCCC/C=C\CC1CC(=O)OC1=O]

Since it may be preferred to make artificial leather through a continuous process, it is preferable to develop the procedure of simultaneous curing (co-curing) the base layer and the foamed layer. However, the curing schedules for these two layers can be different, depending on the protocols used. The curing schedule for the base layer can be 120° C. for 2 hrs and 150° C. for 5 hrs, whereas the curing schedule for the foamed layer can be 30 min at 160° C. Therefore, it is preferred to combine these two curing schedules in order to co-cure two layers of leather.

Following the synthesis of the resins, the preparation of separate layers of the leather can be accomplished.

### Preparation of Foamed Layer Based on ECO

The foamed layer was produced by using thermal curing of Epoxidized cottonseed oil (ECO) with anhydride in the presence of foaming agent. This is most preferred to form porous and flexible foam, needed for leather application. Dodecenyl succinic anhydride is most preferred.

ECO-anhydride formulations (varying different ratios of ECO: DDSA based on equivalent weight) with catalyst (BV-CAT 7) were prepared. Following this, blowing agent, namely: azodicarboxamide and accelerator of foaming—zinc oxide were added to them.

After curing for 30 min at 160° C., the formation of ECO-based foam was complete. The material is flexible. It is soft and has a feeling of “memory foam” product. The flexibility and softness of these foams is attributed to the long aliphatic chain, presented in dodecenyl succinic anhydride and aliphatic chains presented in ECO.

FIG. 2 shows the microscopic images of ECO-based foams. It was observed that, as content of anhydride in the formulation decreases, the formation of more porous network occurs. The reason for that is believed to be a diminished crosslink density in the case of lower content of anhydride in the system, which allows formation of more porous foamed structure.

### Preparation of Base Layer from ECO

Base layer form ECO was prepared by mixing ECO anhydride and catalyst (BV-CAT 7). The ratio of ECO to DDSA was 1:0.75; 1:1; and 1:1.5 (based on equivalent weight). It was defined that ratio of ECO to DDSA of 1:1.5 is the best for producing the base layer, since it allows formation of crosslinked network with sufficient flexibility and chemical resistance.

Properties of ECO base layer, made with BV-CAT 7 catalyst and ratio of ECO to DDSA: 1: 1.5 are given in Table 1. This film has low hardness and extremely high flexibility. These properties make a ECO base layer suitable for the application in the cottonseed oil-based artificial leather.

TABLE 1
Properties of base layer from ECO

| Properties | Ratio 1:1.5; 3% BV-Cat 7 |
|---|---|
| König hardness (sec) | 12 |
| Thickness (μm) | 220 ± 3.85 |
| Cross Hatch Adhesion | 5B |
| Pencil hardness | 7B |
| Reverse impact (in · lb) | >168.56 |
| Mandrel Bend* | PASS |
| MEK DR | 200 |
| MEK DR (Mar) | 50 |

### Preparation of Base Layer from AECO

The properties of the base layer from acrylated epoxidized cottonseed oil (AECO) were also explored. The layers from this resin can be also used in leather preparation, namely in preparation of a base layer. UV-curing technology was used in order to transform AECO into crosslinked network. This technique has several advantages over thermal curing, including, but not limited to, speed, efficiency, and energy consumption.

The properties of the UV-curable AECO-based coatings are shown are shown in Table 2. These coatings were formulated with 1% of photoinitiator. Overall, these coatings have excellent chemical resistance, low hardness, and good flexibility.

TABLE 2
Properties of AECO base layer

| Properties | 1% of Photoinitiator |
|---|---|
| König hardness (sec) | 49 |
| Thickness (μm) | 101.6 ± 2.57 |
| Cross Hatch Adhesion | 1B |
| Pencil hardness | 8B |
| Reverse impact (in · lb) | 3.92 |
| Mandrel Bend* | 16 |
| MEK DR | >400 |

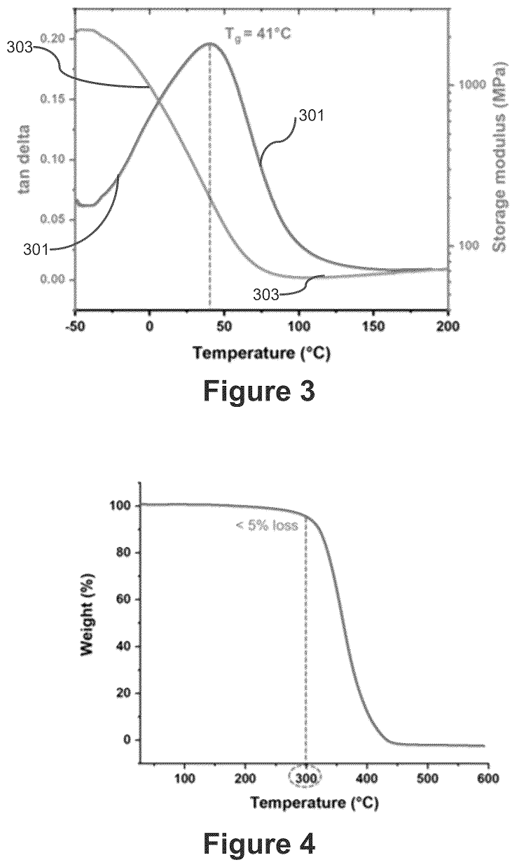

FIG. 3 shows results from Dynamic mechanical analysis of the UV-cured AECO base layer. The peak of tan delta curve 301 in FIG. 3 is defined as the Glass transition Temperature (Tg) of the material. The Storage Modulus is the curve 303. As it can be observed, these films exhibit relatively low T_{g} (41° C.), which indicates their flexible nature. Such relatively low Tg is related with the vegetable oil nature of the film and is due to the presence of long alkyl chains in the AECO structure. This factor is only beneficial for the leather applications and again shows its relative flexibility.

Another technique, which can be used for preparation of base layer from AECO is dual curing. This includes both: thermal and UV-curing at the same time. The main reason for dual curing was to discover whether the flexibility of the layer can be improved even more (in comparison to UV-curable layers with plasticizer). Properties of dual cured coatings are tabulated in Table 3.

TABLE 3
Properties of AECO dual cured films for the base layer

| | | Properties | | | | | | |
|---|---|---|---|---|---|---|---|---|
| Initiator | | König | | Cross | | Reverse | | |
| content | | hardness | Thickness | Hatch | Pencil | impact | Mandrel | MEK |
| Th* | Ph** | (sec) | (μm) | Adhesion | hardness | (in · lb) | Bend*** | DR |
| 3 | 3 | 39 | 94.63 ± 3.87 | 3B | B | 15.68 | 28 | >400 |
| 2 | 2 | 33 | 95.27 ± 4.11 | 3B | 3B | 7.84 | 28 | >400 |
| 3 | 2 | 31 | 77.03 ± 4.13 | 3B | 3B | 7.84 | 28 | >400 |
| 2 | 3 | 37 | 94.57 ± 4.56 | 3B | 2B | 7.84 | 28 | >400 |

*Th—Thermal Initiator (TBPB)
**Ph—Photoinitiator (Omnirad 1173)
***Percent elongation

As it can be seen from Table 3, all coatings have excellent chemical resistance (MEK DR>400). They exhibit good adhesion to steel substrates and relatively good flexibility. The content of initiators in the formulations does not alter the properties to high extent. It is important to mention that these coatings have better flexibility in comparison to UV-cured ones.

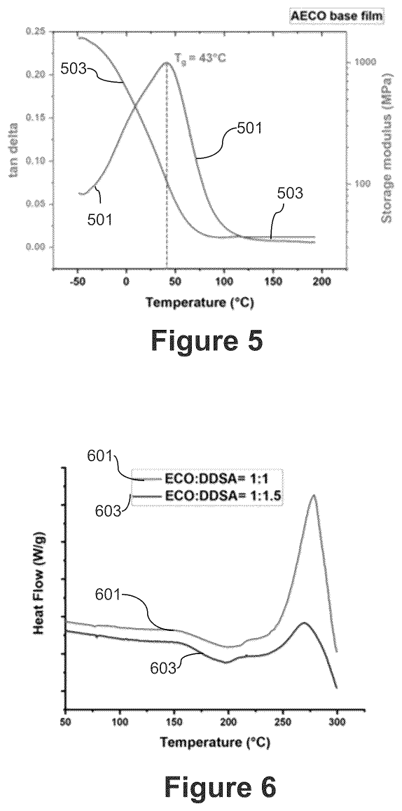

FIG. 4 shows the TGA curve of AECO dual-cured base film. This film was formulated with 2% of thermoinitiator and 3% of photoinitiator. As can be observed, the major weight loss of the base film occurs only after 300° C. Before this temperature, less than 5% weight loss can be observed. This indicates that this film has good thermal stability. In terms of glass transition temperature, this film exhibits similar T_{g} (43° C.) to AECO UV-cured film (FIG. 5). In FIG. 5, the tan delta line is 501 and the Storage Modulus line is 503.

Overall, it is observed that AECO is a good candidate to create the base layers of leather. This can be done using several approaches including UV-curing and Dual-curing.

Leather prototypes are made by applying the foamed layer on top of the base layer and additionally attaching fabric layer (cotton cloth) with the help of the base formulation.

In order to simplify and accelerate the entire manufacturing process of cottonseed oil-based leather, it is also possible to co-cure the base layer with the foam layer. As one example, the base layer formulation may be applied on glass panels with a drawdown bar. Following this, the foamed layer formulation can be dripped carefully with the help of the pipette on top of the base layer. The glass panels can then be placed vertically to ensure the full coverage of the base layer by the foam layer. The glass panels can then be cured thermally in the oven with the following curing schedule: 120° C. for 2 hrs and 160° C. for 5 hrs.

Alternatively, one can cure both layers at 160° C., for 30 min. It is believed that the co-curing of layers using a shorter time and higher temperature should lead to formation of foamed layer on top of base layer. The same procedure can be used with silicon molds.

In some experiments, when the base layer was cured at 160° C., it was noticed that this layer did not have good chemical resistance, which is related to the incomplete curing of ECO with DDSA. Differential scanning calorimetry was performed to understand better the curing behavior of ECO with DDSA at 160° C. After curing samples at 160° C. for 30 min, samples for DSC were prepared. FIG. 5 shows the DSC curves of samples prepared with different equivalent ratios of epoxy to anhydride (ECO: anhydride), namely 1:1.5 to 1:1.

In FIG. 6, the line for the ECO: DDSA at 1:1 is shown as 601, while the line for the 1:1.5 is shown as 603. The DSC graph in FIG. 6, shows the presence of exothermic peaks around 250-300° C., which indicates additional curing is occurring. The smaller peak for the formulation with an epoxy-to-anhydride ratio of 1:1.5 shows that this peak is not attributed to the decomposition of the base layer.

It is important to mention that the DSC curves from FIG. 6 are very similar to the DSC curves of the same formulations cured at 120° C. for 2 hrs and 150° C. for 5 hrs. This shows that an extended curing time at high temperatures may not be necessary, since it does not lead to the completion of this process.

In order to improve the curing process of the base layer of the leather, a set of experiments were performed. The base layer film was prepared by mixing ECO, DDSA, and the catalyst. Then it was cured using different curing schedules, after which the fraction of the crosslinked material was determined using Soxhlet extraction. Table 4 shows the results from Soxhlet extraction of the base film cured using two different curing schedules, namely 120° C. 2 h; 150° C. 5 h and 160° C. 30 min.

TABLE 4
Gel content of layers

| Formulation | Gel content |
|---|---|
| Base: 120° C. 2 h; 150° C. 5 h | 96.9% |
| Base: 160° C. 30 min | 91.3% |

It can be seen from Table 4 that the gel content of the base film cured under different curing schedules is above 90%. The crosslinked fraction of the base film, cured at 120° C. for 2 h and 150° C. for 5 h, is higher compared to the film cured at 160° C. 30 min. However, this difference is not crucial, considering that this film was cured for an additional 6.5 hours.

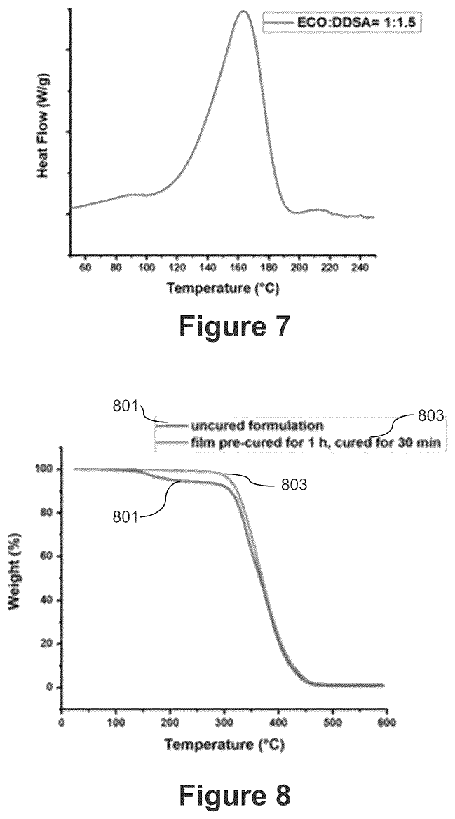

The formulations containing epoxidized cottonseed oil, anhydride, and catalyst were pre-cured at 120° C. This pre-curing temperature was chosen based on results obtained from DSC analysis. FIG. 7 shows the DSC curve of the base formulation right after the preparation process (first heating cycle).

FIG. 7 depicts the DSC curve, which shows the presence of a sharp exothermic peak around 160° C., with its onset occurring near 120° C. Therefore, this temperature was chosen as the pre-curing temperature.

The pre-curing was performed for 1 h, 1 h 30 min and 2 hours (in the vials). After the pre-curing stage, the formulations were applied on steel panels and cured in the oven for 30 min at 160° C. Following this, the samples were taken for the Soxhlet extraction. The results from this experiment are presented in Table 5.

TABLE 5
Gel content of the base layer, prepared with the pre-curing stage

| Formulation | Gel content |
|---|---|
| Pre-cured 1 h | 94.0% |
| Pre-cured 1 h, 30 min | 94.5% |
| Pre-cured 2 h | 93.8% |
| Cured 160° C. 30 min | 91.3% |

It can be seen from Table 5 that the pre-curing stage has a positive impact on the gel content of the base film, increasing up to ±3%. It should be noted that after the pre-curing stage, there was a noticeable increase in the viscosity of the formulations. This can be attributed to the binding of the anhydride with ECO at the early stage of the reaction, reducing the chance of DDSA evaporation (which usually occurs at the beginning of the curing process at elevated temperatures).

FIG. 8 shows the thermogravimetric curves of the uncured base layer formulation and cured base layer film (curing schedule: pre-curing 1 h 120° C.; 30 min 160° C.).

It can be noticed from FIG. 8 that for uncured base formulation 801, there is a notable loss in mass around 120-200° C. This mass loss is attributed to the evaporation of the DDSA. However, the pre-curing process most probably provides the immediate binding of the anhydride, which restricts its evaporation. The second thermogravimetric curve in

The line 803 in FIG. 8 shows that the base layer pre-cured at 120° C. for 1 h and cured at 160° C. for 30 min is stable up to ˜300° C.

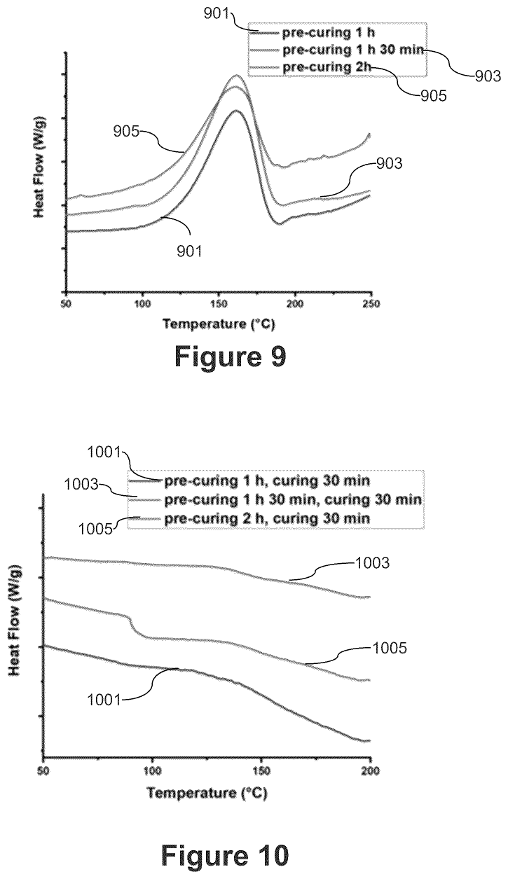

To study the pre-curing process further, the DSC was performed on the base formulations, right after the pre-curing stage. FIG. 9 shows the DSC curves after the first heating cycle. The line 901 shows the DSC curve for a sample with 1 hour of precuring, while line 903 is the curve for a sample with 1.5 hours of precuring and line 905 is the curve for a sample with 2 hours of precuring.

The DSC curves, depicted in FIG. 9, were compared with the DSC curve shown in FIG. 7. It was found that the reaction enthalpies (ΔH) decreased with the increase of precuring time. For example, the reaction enthalpy of the formulation taken for DSC in the uncured state was 104 J/g, whereas the reaction enthalpy for the formulation after pre-curing for 1 hour was 59 J/g. This confirms the reaction progress during the pre-curing stage.

FIG. 10 shows the DSC curves of the base films cured by the following curing schedule: precuring at 120° C. (1 h; 1 h 30 min or 2 h) followed by curing at 160° for 30 min, lines 1001, 1003 and 1005, respectively. FIG. 10 shows that the DSC curves of the base films after the first heating cycle do not show any exothermic peaks, which indicates the completion of the reaction. It should be noted that the MEK double rubs for the base films, prepared by the procedure mentioned above, showed a value of ˜200. This indicated good chemical resistance of these systems. Since there was no notable difference observed in the determined properties of the base films with varying pre-curing times, the final curing schedule for the base layer film will be defined as follows: 120° C. for 1 h (pre-curing); 160° C. for 30 min. This curing schedule is highly desirable for the continuous manufacturing process of the leather.

The next step was to improve the formulation of the foam layer. This included determining the amount of the blowing agent (ADA) and the accelerator of foaming (ZnO) that provided the best foam layer. Table 6 gives the set of the formulations prepared for the experiment.

TABLE 6
Composition of foaming layer formulations

| | Fraction | Fraction |
|---|---|---|
| Formulation # | of ADA, pph | of ZnO, pph |
| F1-0-0 (control) | 0 | 0 |
| F2-1-0.5 | 1 | 0.5 |
| F3-2-0.5 | 2 | 0.5 |
| F4-3-0.5 | 3 | 0.5 |
| F5-4-0.5 | 4 | 0.5 |
| F6-5-0.5 | 5 | 0.5 |
| F7-3-0 (control 2) | 3 | 0 |
| F8-3-0.25 | 3 | 0.25 |
| F9-3-0.5 (=F4-3-0.5) | 3 | 0.5 |
| F10-3-0.75 | 3 | 0.75 |
| F11-3-1 | 3 | 1 |
| F12-3-1.5 | 3 | 1.5 |

The formulations presented in Table 6 were prepared, poured into silicone molds and cured at 160° C. for 30 min. The fraction of ADA in the formulations was varied from 0 to 5 pph, whereas the fraction of ZnO-from o to 1.5 pph.

After the curing process, it was noticed that the foam with no accelerator of foaming did not noticeably expand. This was expected since the decomposition temperature of ADA is higher than 160° C.

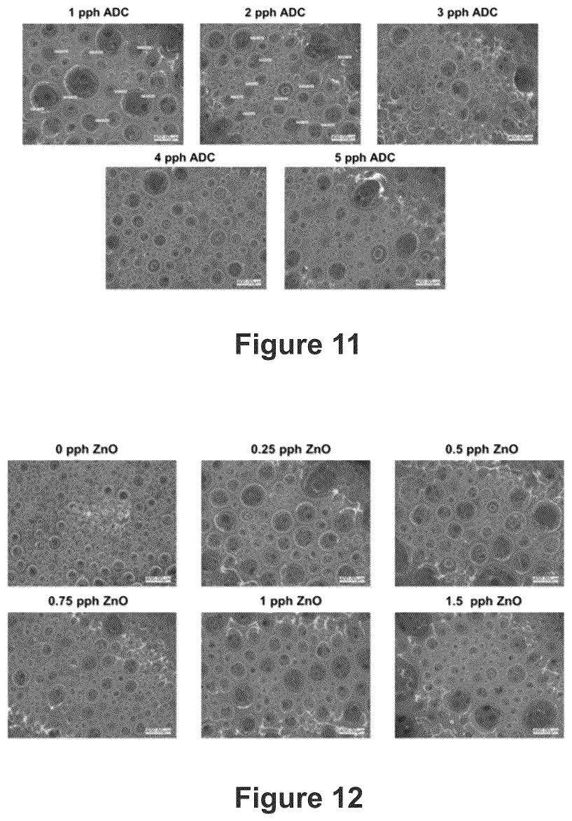

It was also noticed that increasing the fraction of the blowing agent in the formulations results in slightly higher foam expansion. It should also be noted that no notable effect was observed in the foams made with 3 pph of the blowing agent compared to those made with 4 and 5 pph. Results from optical microscopy of the foams are shown in FIGS. 11 and 12.

Based on the results obtained from optical microscopy, it was observed that there is no strong correlation between the pore (cell) size and the amount of blowing agent or accelerator of foaming added. The dominant pore size varies from ˜300 μm to ˜1000 μm, with rare inclusions of pores with a size of ˜2000 μm or smaller than 300 μm. To fully understand the effect of ADA and ZnO on the properties of foams and their performance in leather applications, scanning electron microscopy and microcomputed tomography were performed.

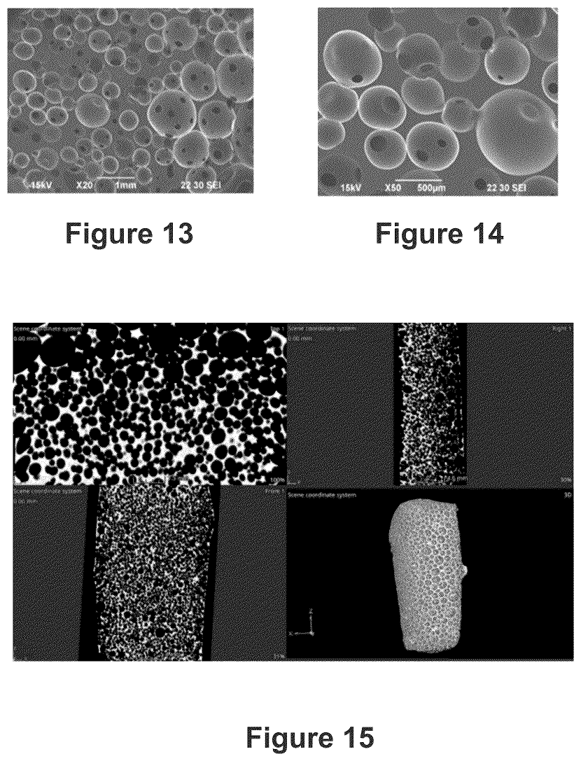

Generally, it was observed from SEM scans that the ECO-based foams have heterogeneous cell structures (cells are randomly distributed; most cells are closed). No clear trend was observed between the amount of blowing agent added to the formulation and the cellular structure. An example of the foam can be seen in FIGS. 13 and 14.

A clear trend was observed within foamed samples made with different amounts of the accelerator (ZnO). This can be explained by the uniform growth of the cells over the period of curing with a higher amount of accelerator (0.75 pph). When the content of the accelerator in the foaming system is low, the decomposition of ADA occurs at a lower rate, and this leads to the non-uniform growth of cells (some cells form immediately, while others form later). Therefore, the presence of very big cells can be observed in the foams with 0.25 pph of ZnO. Also, due to the Ostwald ripening effect, bigger cells can become even coarser, which will result in a broader size distribution of foam's cells.

The MicroCT scan of the sample made with 3 pph ADA and 0.5 pph of ZnO is shown in FIG. 15. The porosity of the prepared samples, defined from MicroCT imaging, is given in Table 7.

TABLE 7
Porosity of ECO-based foams

| | TOTAL | MATERIAL | AIR | | |
|---|---|---|---|---|---|
| SAMPLE | VOL., mm³ | VOL., mm³ | VOL., mm³ | MATERIAL % | AIR % |
| F2-1-0.5 | 3947.871 | 1358.928 | 2588.943 | 34.42 | 65.58 |
| F3-2-0.5 | 4722.782 | 1346.707 | 3376.075 | 28.52 | 71.48 |
| F4-3-0.5 | 4390.667 | 1347.044 | 3043.624 | 30.68 | 69.32 |
| F8-3-0.25 | 3023.706 | 1050.069 | 1973.637 | 34.73 | 65.27 |
| F10-3-0.75 | 4132.772 | 907.334 | 3225.438 | 21.95 | 78.05 |

It can be seen from Table 7 that the porosity of ECO-based samples varies from 65% to 78%. There is a clear trend between the amount of foaming accelerator and porosity data. The higher the content of the accelerator, the more porous the foams (65% air with 0.25 pph ZnO; 69% air with 0.5 pph ZnO and 78% air with 0.75 pph).

It was also observed that the preparation process of ECO-based foams is an important factor, which defines the morphology of foams. In a previous quarter, it was concluded that the preferred curing schedule for the system ECO-DDSA is 120° C. and 1 hour (pre-curing) followed by final curing at 160° C. for 30 min.

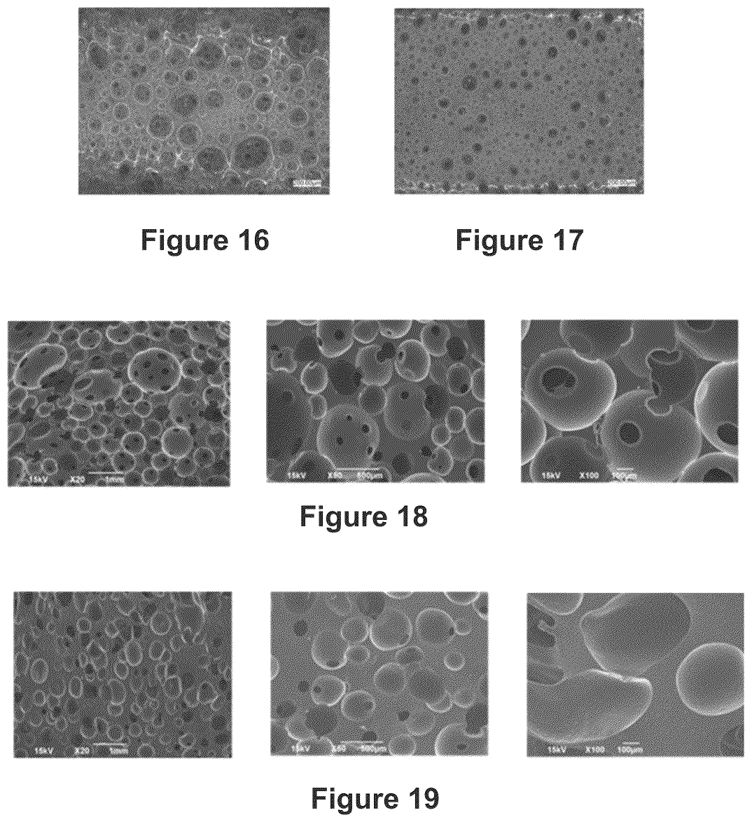

In the preparation process of foams, the pre-curing stage can be performed in two ways: (1) Pre-curing is performed with the addition of ADA and ZnO (method 1); and (2) Pre-curing is done only with ECO, DDSA, catalyst, and ADA. ZnO is added later (after precuring is completed) (method 2). Microscopic images of ECO-based foams prepared using the two different methods and are depicted below in FIGS. 16 and 17.

As can be seen, the appearance of the foams is very different: the foam prepared by method 1 (FIG. 16) is more porous than the foam prepared by method 2 (FIG. 17). Moreover, the foams prepared by method 2 contain some residues of ADA.

The presence of ADA residues in the foam sample might be attributed to the imbalance between the blowing process and curing. Since the viscosity of the pre-cured resin is high, the formation of cells is suppressed. The polymer network forms faster than the gas expands. The differences in morphology of foams were further explored by Scanning Electron Microscopy. Compare the images in FIG. 18, which show samples ore-cured with ADA and ZnO with the images in FIG. 19 showing a sample pre-cured without ADA and ZnO. It can be seen that the foam, precured without ADA and ZnO, has fewer cells and most of them are closed cells. This correlates with the porosity data obtained from MicroCT analysis (74% versus 50%). The porosity values are shown in Table 8.

TABLE 8
Porosity of foamed layer in commercially available bio-based leathers

| | TOTAL | MATERIAL | AIR | | |
|---|---|---|---|---|---|
| SAMPLE | VOL., mm³ | VOL., mm³ | VOL., mm³ | MATERIAL % | AIR % |
| pre-cured | 1722.629 | 439.903 | 1282.726 | 25.5367 | 74.4633 |
| with ADA | | | | | |
| and ZnO | | | | | |
| pre-cured | 833.431 | 412.551 | 420.880 | 49.5003 | 50.4997 |
| without | | | | | |
| ADA and | | | | | |
| ZnO | | | | | |

In order to understand the structure of foamed layers in commercially available leather, some samples were studied, namely Desserto cactus leather (the fabric layer was removed) and Vegea grape leather

As noticed, the distribution of cell size in commercial samples is broad. Interestingly, the cells are also observed in the base layer of Desserto leather. The porosity values of foamed layers in commercial leather are lower in comparison to ECO-based leather. The porosity data are shown in Table 9.

TABLE 9
Porosity of foamed layer in commercially available bio-based leathers

| | TOTAL | MATERIAL | AIR | | |
|---|---|---|---|---|---|
| SAMPLE | VOL., mm³ | VOL., mm³ | VOL., mm³ | MATERIAL % | AIR % |
| Desserto | 19.949 | 11.765 | 8.184 | 58.98 | 41.02 |
| cactus leather | | | | | |
| Vegea grape | 53.238 | 28.638 | 24.600 | 53.79 | 46.21 |
| leather | | | | | |

In order to control the uniform structure of the cells in ECO-based foams, a surfactant, namely TEGOSTAB B89930, was used. TEGOSTAB B89930 is poly (ether-siloxane) block copolymer. Generally, siloxane surfactants are used very often as foam stabilizers in polyurethane foams.

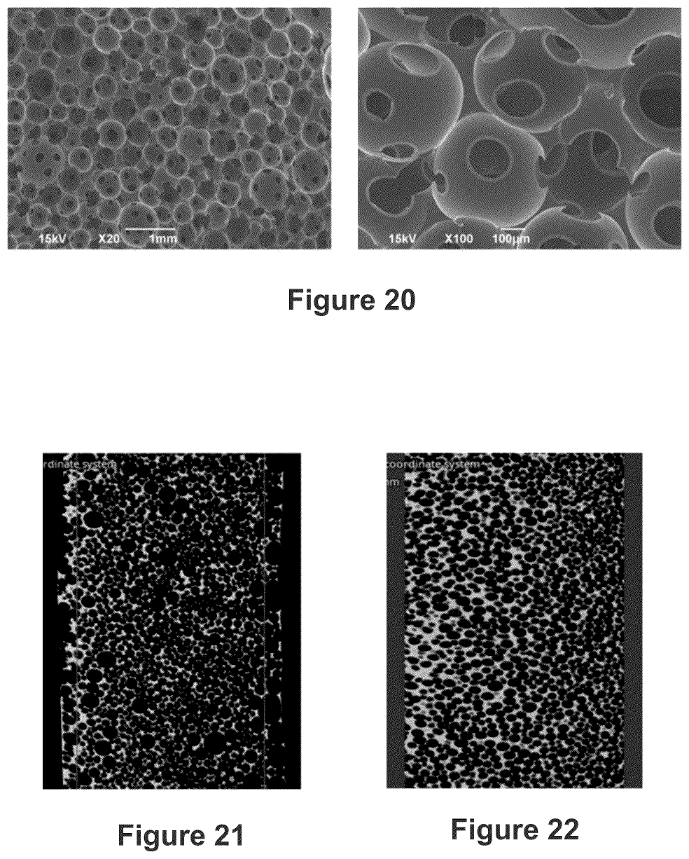

As can be observed from FIG. 20, the cells of the ECO-based foam are uniformly distributed in the presence of surfactant.

MicroCT scans were performed of the foams, made with the surfactant, with or without a pre-curing stage and are depicted in FIGS. 21 and 22. The porosity of foam (a) and (b) are 79% and 68%, respectively. The foam made without the pre-curing process (FIG. 21) still has some coarse cells and its porosity is relatively high. In contrast, the foam made with the pre-curing process (FIG. 22) shows uniform cell size and a lower porosity. The higher porosity for the foam in FIG. 21 can be attributed to the greater blowing efficiency of ADA compared to the gelling efficiency of the ECO-based network.

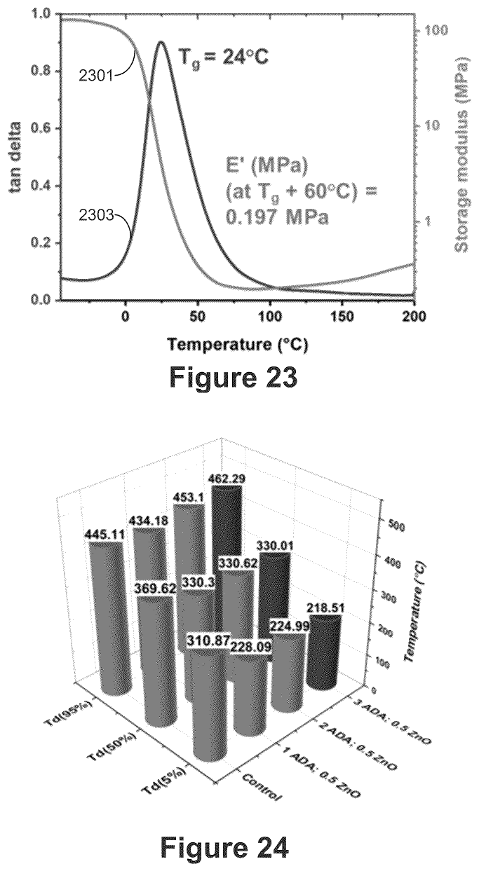

The mechanical properties of the foams were evaluated. Dynamic mechanical analysis was performed on the rectangular foams with known dimensions in single cantilever mode. The representative temperature dependence of tan delta 2301 and storage modulus 2303 curves for sample are shown in FIG. 23. The glass transition temperatures and storage moduli are given in Table 10.

TABLE 10
Dynamic mechanical analysis of ECO- based foams

| Formulation # | T_{g} (° C.) | E′ (MPa) at T_{g} + 60° C. |
|---|---|---|
| F2-1-0.5 | 23.75 | 0.121 |
| F4-3-0.5 | 21.34 | 0.116 |
| F6-5-0.5 | 25.87 | 0.192 |
| F8-3-0.25 | 24.44 | 0.197 |
| F10-3-0.75 | 25.79 | 0.113 |
| F12-3-1.5 | 20.47 | 0.1524 |

It can be seen from Table 10 that foams containing different amounts of blowing agent and accelerator have nearly the same glass transition temperatures and storage moduli. This gives a clear understanding that the mechanical properties of these foams are governed by the ECO-DDSA network. In general, these foams have low T_{g} and storage modulus, which is related to the flexible nature of ECO (due to the long alkyl chains in the structure), as well as DDSA (also alkyl chain in the structure).

It was also found that preparation methods and the presence of surfactant in the formulations do not have a significant impact on the T_{g} or storage modulus. The lack of the effect of the surfactant on the mechanical properties may be attributed to its small amount in the formulation. The results are shown in Table 11.

TABLE 11
Dynamic mechanical analysis of foam
made with 3 pph ADA and 0.5 pph ZnO

| | | | E′ (MPa) |
|---|---|---|---|
| Formulation # | Details | T_{g} (° C.) | at T_{g} + 60° C. |
| F4-3-0.5 | Sample pre- | 21.10 | 0.083 |
| | cured, method 1 | | |
| F4-3-0.5 | Sample pre- | 21.57 | 0.069 |
| | cured, method 2 | | |
| F4-3-0.5 | Sample with surfactant | 20.41 | 0.105 |

In order to increase the glass transition temperature and storage modulus, different types of anhydride for curing with ECO can be used. For example, if MHHPA anhydride is used, foams exhibit higher T_{g}: 39.86° C. and higher modulus E′ (at T_{g}+60° C.): 0.458 MPa. However, these foams have higher rigidity and might be beneficial for applications other than leather.

The thermal stability of the foams was also evaluated. FIG. 24 shows the decomposition temperatures of the foams, prepared with different amounts of blowing agent ADA.

It can be observed that in comparison to the control sample, the foams containing ADA have a lower temperature of decomposition (310° C. for control VS ˜220° C. for foams).

The decomposition of ADA is a complicated process and not very well understood. The decomposition temperatures of ADA, defined from TGA analysis, are given in Table 12. ADA decomposes in several stages, each of which occurs at different temperatures. Earlier decomposition of the ECO-based foams might be related to some additional decomposition of a small amount of ADA at 220° C. It could also be noticed that the temperature at which 95% of the foams decompose is higher for the foams with higher contents of ADA. The ADA decomposition curve shows 0.3% residual weight at 400° C. This residual weight might explain the higher decomposition temperature of the foams containing higher contents of ADA.

TABLE 12
Thermal decomposition of ADA
Decomposition of ADA

T_{d (5%)} = 208.72° C.
T_{d (50%)} = 227.19° C.
T_{d (95%)} = 273.84° C.

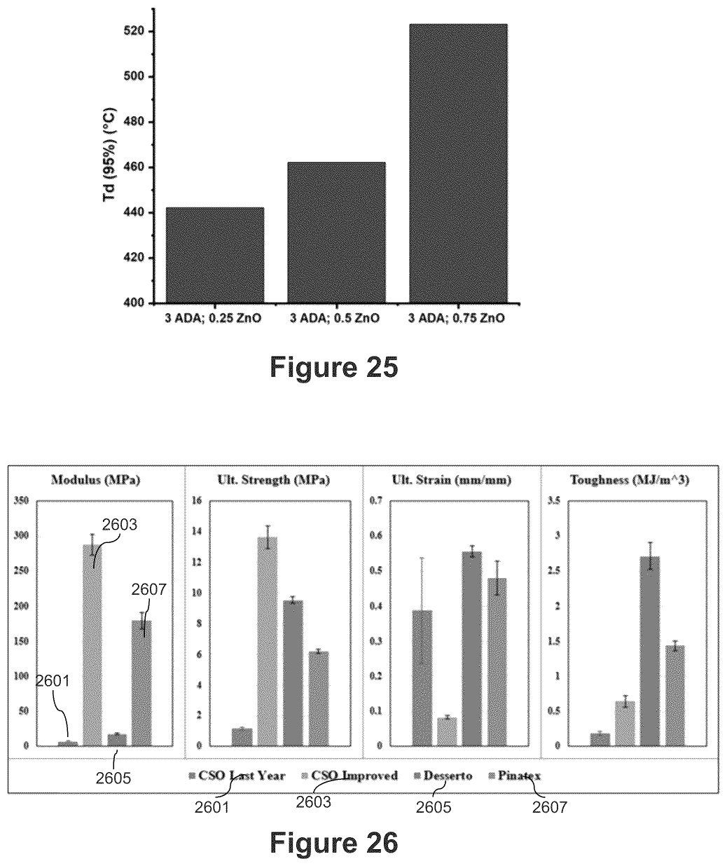

The effect of Zinc Oxide on decomposition of ECO-based foams was also investigated. It is known that zinc oxide has very high thermal stability. Therefore, the higher its amount in the composition, the higher the decomposition temperature (T_{d (95%)}) was observed with the data presented in FIG. 25.

### Observations

These examples demonstrate that vegetable oils, such as cottonseed oil, can be used as the main compound for the preparation of new generation artificial leathers. The bio-based artificial leather was prepared using classic three-layer structured approach. Two polymeric resins were synthesized from an example vegetable oil (in this example cottonseed oil). Two forms of the vegetable oil, epoxidized cottonseed oil (ECO) and acrylated-epoxidized cottonseed oil (AECO)), were used in the fabrication of base and foamed layers of the artificial leather.

Application of ECO showed good results in the production of foam and the base layers of leather. Using thermal curing of ECO along with DDSA anhydride, in the presence of proper blowing agents, ECO can be converted into foamed material. This foam layer exhibits good flexibility and softness, needed for the leather application. Properties of these foams are very similar to those of the foams used in commercially available artificial leather. The base layer of the leather can also be prepared using the ECO as a main compound. The films from this resin have extreme flexibility, needed for the leather application.

AECO was found as another potential resin for the preparation of base layers. It was found that either dual curing or UV-curing of AECO resin can be used. Showing good flexibility, thermomechanical properties and chemical resistance, dually cured or UV-cured AECO is a good candidate for the preparation of base layers leather. Overall, the prepared layers can be used in different combinations to make leather prototypes.

The co-curing of the base layer from the ECO and the foamed layer from ECO was also studied. The co-curing of layers showed that two-layered structure material can be produced at once, making the entire process easier and more economically feasible.

Further, the performed analyses give important insights into the use of ECO-based foams in the new generation of artificial leather. It was shown that the porosity and morphology of ECO-based foams can be tuned by changing their composition and preparation process. Based on these results, it can be concluded that the ECO-based foams can be used as one of the layers in artificial leather.

As mentioned earlier, commercial leather samples do not contain uniformly distributed cells in their foamed layers. Moreover, most of the cells have closed-cell structures, even though it is known that closed-cell foams are generally more rigid. The same structure is observed in the ECO-based foams and they still show excellent flexibility and softness, which can be further adjusted according to the application using different anhydrides. As a replacement for existing bio-based artificial leather (Desserto cactus leather; Vegea grape leather, etc.), it is suggested to use DDSA anhydride, since foams made with this anhydride closely match the internal structure of the commercial foams used in artificial leather.

It is worth mentioning that artificial leather is generally less breathable than real leather, which is considered a disadvantage of the former. Such a property might be partially attributed to the fact that the foam layers in the artificial leather have closed cells, which create an air barrier and prevent air from moving through them. Therefore, having at least some open cells in the ECO-based leather should be beneficial.

In addition, it is also known that the mechanical properties of artificial leather are affected by the properties of the cells in the foams (cell uniformity, diameter, shape, wall thickness, etc.). With a uniform distribution of cells, one can achieve foams with better mechanical properties. Fine and homogeneous cell structures can be obtained with the help of surfactants. In general, the cell growth in foams is disrupted by two phenomena: the Ostwald ripening and the cell drainage. Ostwald ripening contributes to the presence of large cells in the foams, since the gas in small cells transfers into larger ones (in order to equilibrate the pressure difference between large and small cells). If the gas transfer is not controlled, heterogeneous structures with a high number of coarser cells will be formed. By using surfactants, which can aggregate at the surface between air and foaming liquid, Ostwald ripening can be prevented. Cell drainage also disrupts the uniform formation of cells. When the gas volume fraction exceeds 70-75%, spherical cells start forming multisided polyhedrals. If cells are open too early in the foaming process, the foam may collapse (this was not observed in ECO-based foams).

To conclude, the preparation of cottonseed oil-based artificial leather was done. Separate layers of leather (base and foamed layers) were prepared, and their preferred compositions and curing procedures were defined. The preferred curing schedule for the base layer of the leather was determined by conducting a set of experiments, including gel content, differential scanning calorimetry, thermogravimetric analysis, etc. It was defined that for a successful curing process, the pre-curing stage of the base formulation is needed. The curing schedule for the base formulation was defined as follows: 120° C. for 1 h pre-curing followed by a second stage curing at 160° C. for 30 min. The experimental study determining the preferred amount of blowing agent and accelerator in the foamed layer of the leather was performed. Analysis of ECO-based foams using optical microscopy, scanning electron microscopy, and microcomputed tomography was performed in order to fully understand the effect of ADA and ZnO on the internal structure of foams. It was observed that the porosity of the foams can be changed by either varying the content of the accelerator (ZnO) in the formulations or by changing the method of preparation of foams. ECO-based foams exhibit high porosity-from 65 to 78%, which is higher than commercial samples. However, a lower porosity can be obtained by changing the preparation method (namely, including the precuring process). Commercial leather samples do not exhibit uniform cell distribution in the same way as ECO-based foams. Therefore, even the method without including the pre-curing stage can be potentially applied to fabricating leather samples. However, it is worth mentioning that by incorporating the surfactant in the foaming formulations, it is possible to get a uniform distribution of cells in the foams. The thermo-mechanical properties of the foams were analyzed by DSC, TGA, and dynamic mechanical analysis. These foams exhibit low glass transition temperatures and low moduli, which is typical for flexible polymer foams. Overall, preferred ECO-based foams along with preferred ECO base layer can be used for the preparation of the next generation cottonseed oil-based artificial leather.

### Example 2

Further experiments were performed to assess manufacturability of the synthetic leathers described herein.

### Materials

Details on synthesizing the epoxidized cottonseed oil (ECSO) are provided in part one of this application. Azodicarbonamide as foaming agent, zinc stearate foaming accelerant (purum, 10-12% Zn basis), dodecenylsuccinic anhydride (DDSA), tetrahydrophthalic anhydride (THPA), and DER 331 bisphenol a diglycidyl ether (BADGE) epoxy resin were purchased from Sigma-Aldrich. BV-CAT 7 was purchased from Broadview Technologies Inc. Diethylenetriamine 98.0% was purchased from TCI America. Tegostab B 8993 surfactant was provided by Evonik.

### Results and Discussion

### Artificial Leather Development—CSO Leather Procedure for Continuous Manufacturing

The previously used manufacturing method for CSO leathers was time-consuming and further improvements are needed for semi-continuous manufacturing. An improved manufacturing procedure was then developed that could be easily adapted to continuously produce CSO leathers.

The new procedure starts with applying PTFE coated fiberglass tape onto the fabric substrate. For oven curing, the cloth was then taped down onto a glass substrate using PTFE tape. For continuous manufacturing, the cloth would be directly fed through a conveyor furnace. The cloth was then saturated with the resin of the formulation without the foaming agent and cured at 160° C. for 30 minutes, long enough to spread the resin throughout the cloth evenly to prevent the resin with the foaming agent from being absorbed into the cloth. Resin of the formulation with foaming agent was then added on top and placed in the furnace and cured at 160° C. for 30 minutes. The tape was then easily peeled off revealing an unsaturated cloth surface. This bottom-up method (building the leather from the bottom, cloth, to the top foamed layer) allows for much quicker production of the CSO leather (only needing two curing steps) without the need to remove each layer from a substrate and then glue them together.

### Formulation Improvements and Woven Canvas Fabric

Tensile testing on the previously developed ECSO leathers revealed that improved properties were needed for commercial use. A variety of solutions were proposed and subsequently trialed to improve the mechanical properties. Different anhydride curing agents were tested to increase flexibility. Both resins were precured with anhydrides to more closely control the viscosity and therefore the curing and foaming characteristics. Less foaming agent and foaming agent accelerator were added to increase the toughness. A stiffer woven canvas cotton fabric layer was used to increase the strength.

When precuring the CSO resin with an anhydride, it was found that the reaction was slow enough at 100° C. that enough anhydride needed to fully cure the system and the resin would not solidify. The best results were obtained by precuring the system at 100° C. for 2 hours. This greatly increased the viscosity of the resin, allowing for much higher quality foams to be produced. This also increased the crosslinking density of the final cured product producing a much stronger foam. It also allows for much thinner foams to be produced consistently without the need for precise leveling.

Precuring with amines and a commercial epoxy resin that were mixed with the ECSO to increase the strength. However, when pre-curing with an amine (DETA) and a commercial epoxy (DER 332 BADGE) it was found that the BADGE was not miscible with the ECSO and caused the foaming agent and foaming accelerant to agglomerate.

### Tensile Testing of Woven Canvas CSO Leather

From testing a variety of solutions to increase the mechanical properties, four major changes were made to the formulation and preparation of the cottonseed oil (CSO) leathers. The first change was to incorporate a different anhydride curing agent that resulted in a more flexible and bend resistant CSO leather. The formulation tested used 50% THPA (stronger) and 50% DDSA (more flexible), but DDSA provides adequate strength so future formulations will be 100% DDSA. The second change is to the preparation. After the anhydride curing agent was added, the formulations were pre-cured at 100° C. for 2 hours. The third change was to the amount of foaming agent. Since the viscosity was increased using precuring, the amount of foaming agent needed to foam went from 5 phr to 1 phr. This increased the curing rate of the resin and increased the flexibility due to lower inorganic solid filler. The fourth change was to use a stronger/stiffer cotton backing fabric. The one selected was stiffer than the CSO foamed layer which prevented cracking of the foamed/top layer before catastrophic fabric failure. To further improve the CSO leather, the resin could be precured for longer, the amount of foaming agent could be further decreased, and the foamed layer could be made thinner.

Three samples were tensile tested: the improved CSO, Desserto® (cactus filled PU with synthetic fiber backing), and Pinatex® (pineapple mat with binder and coating) leathers. Samples that were 5×3″ were prepared and then cut into five 1×3″ specimens using a new razor blade. The specimens were then tensile tested at a rate of 5 mm/min with a grip distance of 1 inch to determine their mechanical properties.

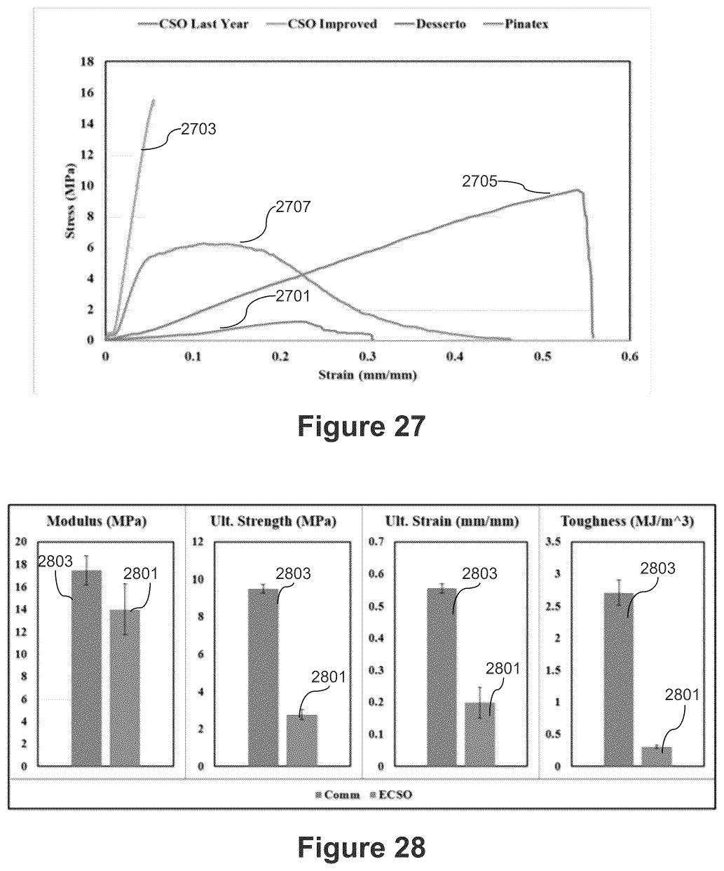

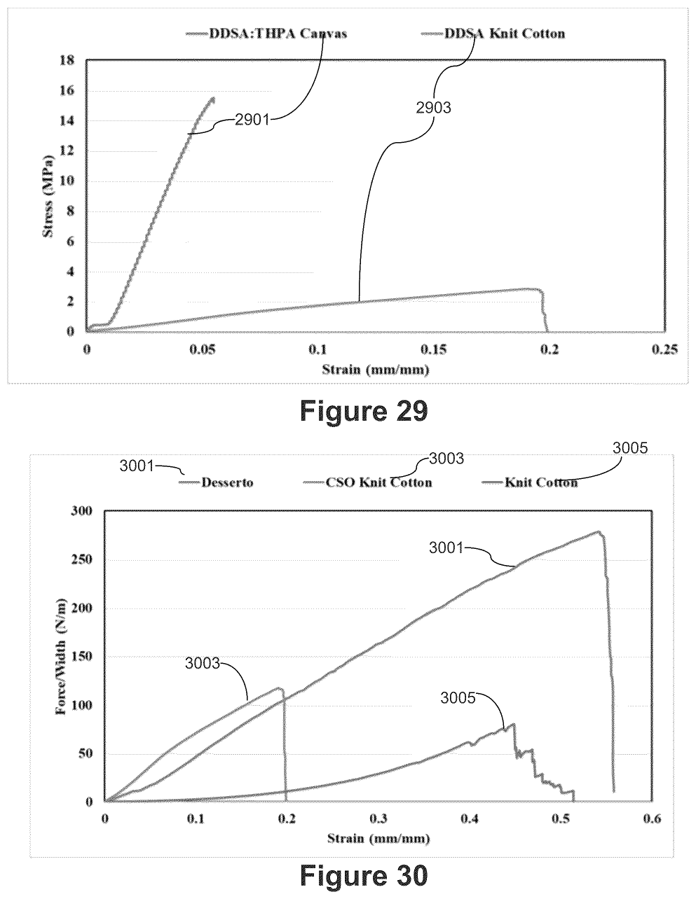

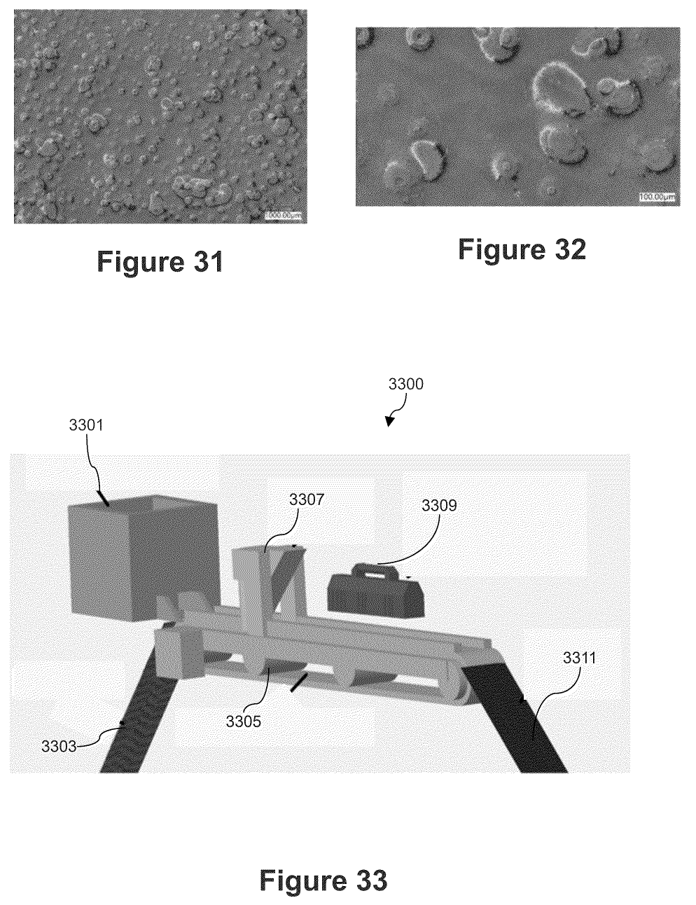

FIGS. 26 and 27 show the improved modulus and ultimate strength of the CSO leather. In FIG. 26, the bars 2601 represent the previously developed cottonseed oil product, while the bars 2603 represent the improved cottonseed oil product, the bars 2605 represent a sample of Deserto® and the bars 2607 represent a sample of Pintex®. In FIG. 27, the line 2701 represents the previously developed cottonseed oil product, while the line 2603 represents the improved cottonseed oil product, the line 2605 represents a sample of Deserto® and the line 2607 represents a sample of Pintex®. These improvements, and the low comparative ultimate strain and toughness, are mainly due to using a stronger fabric backing but would not be possible with the old formulation. This was observed as a lack of cracks as the specimen elongated, demonstrating the increased flexibility of the new formulation.

### Formulation Improvements and Knit Cotton Fabric

Two formulations were developed, one for the foamed layer and one for the adhesive to glue the foamed layer to the cloth layer. For both formulations, the anhydride was changed to 100% DDSA and was added to cure the ECSO in a functional group ratio of 1.5:1. BVCAT-7 was added as a catalyst at 3 phr of the combined weight of ECSO and DDSA to allow for the resin to cure at a lower temperature, 160° C. For the foamed formulation, ADA and ZnSt were then added at 4 and 1 phr, respectively, and dispersed using a mechanical mixer at 600 rpm for 10 minutes. The formulations were then pre-cured at 120° C. for 10 minutes at 500 rpm using a hotplate and magnetic stirrer. The resins were then allowed to cool down to room temperature.

### Tensile Testing of Knit Cotton CSO Leather

The sample preparation for tensile testing and the tensile test parameters are the same as previously reported. Tensile results revealed that the CSO leather has a similar elastic modulus but otherwise lower properties than the commercial synthetic leather (FIG. 28). Testing the knit cotton fabric on its own revealed that the fabric had sufficient ultimate strain and the foamed ECSO coating stiffened the cloth. However, the ECSO leather was unable to elongate to the length of the commercial synthetic leather (FIG. 48). The elongation difference between the two samples is illustrated further in FIGS. 49-51. Decreasing the thickness of the ECSO coating and not saturating the knit cotton with resin can be done to improve the elongation at failure. A toughening agent or different anhydride curing agent may be incorporated into the formulation to increase the ultimate strain, increasing the overall performance of the CSO leather.

### Microstructure Analysis

Microstructure analysis revealed differences in the structure between the commercial and CSO leathers. The average cell diameter of the synthetic leather, 307 μm, is smaller than that of the CSO, 598 μm. This, combined with less foam cells located at the surface of the synthetic leather makes the commercial synthetic leather more resistant to fracture during bending. Since the naturally formed surface layer of the CSO leather is not that thick, an additional layer of resin can be cured on top to increase the strength. Another difference is the thickness of the leather, where the commercial synthetic leather, 1.06 mm, is thinner than the CSO leather, 1.72 mm, which decreases the strength of the synthetic leather composite if a larger portion is a relatively weaker foam. Decreasing the surface tension of the resin through incorporating a surfactant can be done to decrease the foam cell size.

### Surface Texture Microscope Analysis

Images of the surface were taken using a KEYENCE VHX microscope using the optical shadow effect mode (Opt-SEM) to identify the surface texture of the ECSO leather. Opt-SEM uses directional lighting to cast shadows to determine the roughness of the surface. The natural micro-roughness of the surface of the ECSO leather, which gives it less of a plasticky feel. Analysis shows that the roughness is caused by the foaming process, where cells closer to the surface cause a bulging of the surface, giving it roughness. Most protrusions are the product of singular cells, so they are a size similar to the foam cells in diameter, 200-350 μm. The larger bumps result from cell clusters and are around 1 mm in diameter and sometimes larger.

### Sewing

As an experiment, hand sewing was tried on the leather and the process was feasible, demonstrating its potential in products like couches and other upholstered products.

### Conveyor Furnace for CSO Leather Manufacturing

Before building the semi-continuous CSO manufacturing device, the different subsystems and requirements were considered. The subsystems consist of a conveyor system, a heating source, a doctor blade/screed, a spooling system for the cloth, and a reservoir and dispensing system for the resins. As seen in FIG. 33, the lab scale device 3300 includes a resin reservoir 3301, a source of the fiber backing 3303, and a conveyor system 3305. A screed 3307 is used to control and evenly distribute the resin. An infrared heating source 3309 is provided for curing the polymer. The artificial leather is pulled off at 3311.

For the conveyor system, depending on a bottom-up or top-down manufacturing order being used, either the cloth or a non-stick paper will be pulled through and act as the conveyor belt. A controllable motor with a gear reducer will drive the head pulley and belt. Trainers will be situated before and after the head pulley to keep the belt aligned. The belt will be two inches wide with the resin contained within a one-inch width in the center. The edges will then be trimmed off to produce a strip of CSO leather.

For curing the resin and foaming the CSO leather, a short-wave infrared heater may be hung above the belt. The height and power of the heater will be adjustable. Along with the variable conveyor speed, this will allow for precise control over the curing process. A doctor blade/screed will be used for leveling and spreading out the foaming resin for an even foamed layer. Micrometers will be used to control the thickness. A roller can be used to dispense the cloth layer and a reservoir to dispense the resin but is not necessary for the proof of concept. All systems will be connected to a central platform via mounts to allow for easy adjustment of location and swapping of mounts in the case that, for example, UV curing is required again.

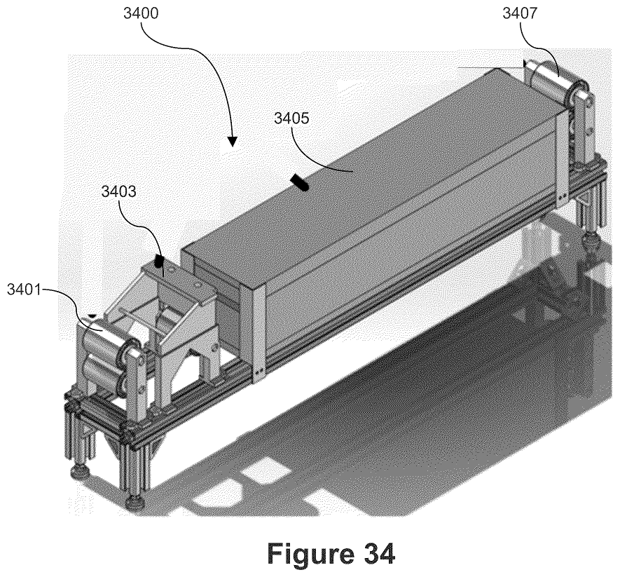

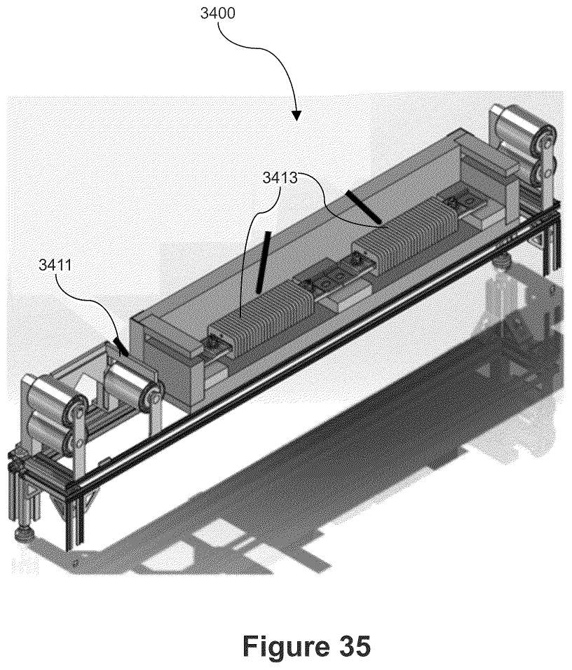

An alternative design for a device 3400 is shown in FIG. 34. This design includes tensioning rollers 3401, screed 3403, insulated furnace box 3405, and drive pulley 3507. The only major change is to the heating system. In this alternative design, the infrared heater was swapped out of an insulated oven with resistance 3413 heaters, shown best in FIG. 35 with the insulating walls removed. FIG. 3500 also shows the screed blade 3411. This design should provide a more controllable temperature profile similar to the procedure preferably used to cure the ECSO foams.

To get a more uniform temperature distribution during heating a variety of different changes can be made. A cover can be put over the finned heater to shield the fabric from the direct radiation from the heaters. The thermocouple can be moved closer to the heaters so that the measured temperature is closer to that of the hottest part of the furnace. The wiring can be changed so that the resistance heaters are in series rather than parallel, which would half the voltage each receives and quarters the heat output. The PID controls can be changed to reduce the temperature overshoot and further decrease temperature oscillations. The finned heaters can also be moved to a separate chamber and the hot air be blown into the chamber with the CSO leather belt.

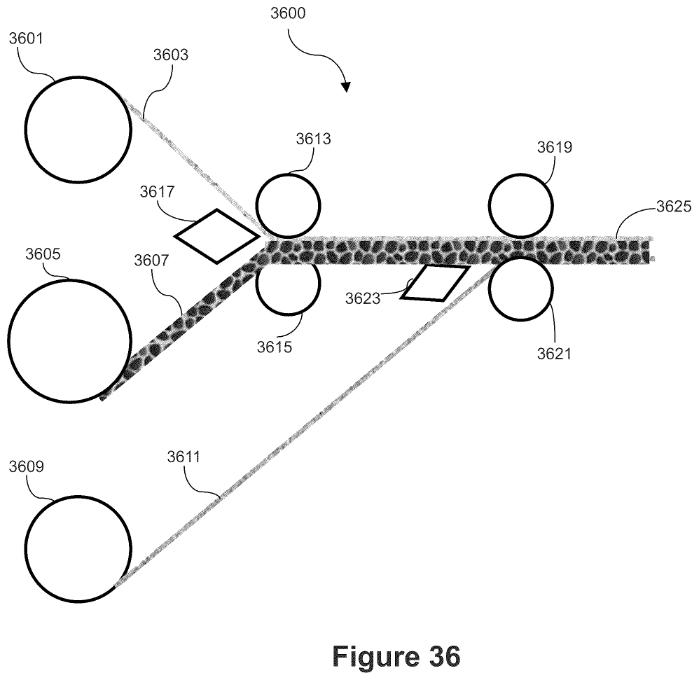

FIG. 36 schematically shows a suitable lamination device by which the base layer, foam layer and fabric layer are brought together. The device 3600 includes a roller 3601 to feed the base layer 3603, a roller 3605 to feed the foam layer 3507, and a roller 4509 to feed the fabric layer 3511. The base layer 3503 and the foam layer 3507 are brought together between compression rollers 3613 and 3615. If an adhesive is required, an applicator 3517 is provided to dispense adhesive at the point where the two layers are brought together. Alternatively, either one or both of the underside of the base layer and the top side of the foam layer is tacky enough on its own or includes an adhesive from a prior step. The fabric layer is brought to the underside of the foam layer and is joined thereto between compression rollers 3619 and 3621. If an adhesive is required to bond the fabric layer, an applicator 3623 is provided. Alternatively, either one or both of the underside of the foam layer and the top side of the fabric is tacky enough on its own or includes and adhesive from a prior step. Once all three layers are joined, the artificial leather product 3625 exits the device.

### Observations

Leather samples similar to commercial ones, such as Desserto® and Pinatex® can now be reliably produced using a batch process. The design, fabrication, and assembly of the system for continuous leather production has been completed.

The features disclosed in the foregoing description, or the following claims, or the accompanying figures, expressed in their specific forms or in terms of a means for performing the disclosed function, or a method or process for attaining the disclosed result, as appropriate, may, separately, or in any combination of such features, be utilized for realizing the invention in diverse forms thereof.

The inventions being thus described, it will be obvious that the same may be varied in many ways. Such variations are not to be regarded as a departure from the spirit and scope of the inventions and all such modifications are intended to be included within the scope of the following claims. The above specification provides a description of the manufacture and use of the disclosed compositions and methods. Since many embodiments can be made without departing from the spirit and scope of the invention, the invention resides in the claims.

What is claimed is:

1. A bio-based artificial leather composition comprising:
a base layer comprising a first polymerized epoxidized vegetable oil;
a foam layer attached to the base layer and comprising a second polymerized epoxidized vegetable oil; and
a fabric layer attached to the foam layer.

2. The bio-based artificial leather composition of claim 1, wherein the first epoxidized vegetable oil is derived from avocado, brazil nut, canola, coconut, corn, cottonseed, flaxseed, grapeseed, hazelnut, hempseed, jambu, linseed, olive, palm, peanut, rapeseed, rice bran, safflower, sesame, soybean, sunflower, walnut, or a mixture thereof.

3. The bio-based artificial leather composition of claim 2, wherein the first epoxidized vegetable oil is modified by acrylation and then polymerized using UV light.

4. The bio-based artificial leather composition of claim 2, wherein the first epoxidized vegetable oil is polymerized by curing with an anhydride.

5. The bio-based artificial leather composition of claim 1; wherein the second epoxidized vegetable oil is derived from avocado, brazil nut, canola, coconut, corn, cottonseed, flaxseed, grapeseed, hazelnut, hempseed, jambu, linseed, olive, palm, peanut, rapeseed, rice bran, safflower, sesame, soybean, sunflower, walnut, or a mixture thereof.

6. The bio-based artificial leather composition of claim 5, wherein the second epoxidized vegetable oil is polymerized by curing with an anhydride.

7. The bio-based artificial leather composition of claims 1, wherein the first polymerized epoxidized vegetable oil is the same as the second polymerized epoxidized vegetable oil.

8. The bio-based artificial leather composition of claim 1, wherein the first and second epoxidized vegetable oil are epoxidized cottonseed oil.

9. The bio-based artificial leather composition of claim 11, wherein the fabric layer is woven cotton.

10. The bio-based artificial leather of claim 8, wherein the epoxidized cottonseed oil is polymerized by curing with an anhydride.

11. The bio-based artificial leather of claim 10, wherein the anhydride is dodecenylsuccinic anhydride.

12. The bio-based artificial leather composition of claim 1, wherein the fabric layer comprises a natural fabric.

13. The bio-based artificial leather composition of claim 11, wherein the fabric layer is woven cotton.

14. The bio-based artificial leather composition of claim 1, wherein the fabric layer is a synthetic fabric comprised of nylon, polyester, acrylic fibers, olefin fibers, spandex, aramid and combinations thereof.

15. A method of preparing a bio-based artificial leather composition comprising:
providing a first epoxidized vegetable oil, and polymerizing the first epoxidized vegetable oil to form a base layer;
providing a second epoxidized vegetable oil, and curing the second epoxidized vegetable oil with an anhydride and foaming agent to form a foam layer;
attaching the base layer to the foam layer; and
attaching a fabric layer to the foam layer.

16. The method of claim 15, wherein the first epoxidized vegetable oil is derived from avocado, brazil nut, canola, coconut, corn, cottonseed, flaxseed, grapeseed, hazelnut, hempseed, jambu, linseed, olive, palm, peanut, rapeseed, rice bran, safflower, sesame, soybean, sunflower, walnut, or a mixture thereof.

17. The method of claim 16, wherein the first epoxidized vegetable oil is modified by acrylation and polymerized by UV light

18. The method of claim 16, wherein the first epoxidized vegetable oil is polymerized by curing with an anhydride.

19. The method of claim 16, wherein the second epoxidized vegetable oil is derived from avocado, brazil nut, canola, coconut, corn, cottonseed, flaxseed, grapeseed, hazelnut, hempseed, jambu, linseed, olive, palm, peanut, rapeseed, rice bran, safflower, sesame, soybean, sunflower, walnut, or a mixture thereof.

20. The method of claim 16, wherein the first and second epoxidized vegetable oil are epoxidized cottonseed oil.
